(19) United States
(12) Patent Application Publication
(10) Pub. No.: US 2010/0140847 A1
(43) Pub. Date: Jun. 10, 2010

(54) Process and apparatus forr vulcazation and moulding of vehicle tyres

(76) Inventors: Mario Secchi, Milano (IT); Maurizio Boiocchi, Milano (IT); Mauro Soatto, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/451,256

(22) PCT Filed: May 10, 2007
(86) PCT No.: PCT/EP2007/004150

§ 371 Date: Feb. 22, 2010

(51) Int. Cl. B28B 13/06; B29D 30/00

(52) U.S. Cl. 264/334; 425/28.1

(57) ABSTRACT

A process for vulcanization and moulding of a pneumatic tyres in tyre manufacture is carried out with an apparatus including a vulcanisation mould and including: a pair of plates adapted to be moved close to each other; a plurality of circumferentially distributed mould sectors; the plates and sectors being mutually movable between an open condition at which they are spaced apart to enable loading of the tyre being worked, and a closed condition at which they define a moulding cavity having a geometric configuration matching the outer surface of the tyre to be obtained. The process includes the steps of: loading the green tyre into the mould; vulcanising the tyre: opening the mould; and exerting a radially outward thrust action on each mould sector.

The present invention relates to a process and an apparatus for moulding and vulcanisation of tyres for vehicle wheels.

In a tyre production cycle it is provided that, subsequently to a building process during which a green tyre is obtained through assembling of the different tyre components, a moulding and vulcanisation process is carried out, said process aiming at stabilising the tyre structure according to a desired geometric conformation usually characterised by a particular tread pattern.

To this end, the tyre is introduced into a vulcanisation apparatus.

Some vulcanisation apparatus are, for example, disclosed in U.S. Pat. No. 6,949,213, in U.S. Pat. No. 4,289,462 or in U.S. Pat. No. 4,580,959.

In particular, U.S. Pat. No. 6,949,213 describes a vulcanizing mould for pneumatic tires includes upper and lower base plates, upper and lower sidewall mould members attached to the upper and lower base plates, respectively; and upper and lower tread mould members attached to the upper and lower base plates, respectively.

The upper and lower tread mould members are constituted of upper segments and lower segments, respectively. The upper and lower segments can be radially expanded and contracted relative to the upper and lower sidewall mould members, respectively.

In operation, the upper and lower sidewall mould members are displaced toward each other so that the upper and lower segments are brought into abutment with each other. Then, a single cam ring is operated to cause all of the segments to be simultaneously displaced radially inwards and relative to the upper and lower sidewall mould members, with the upper segments in abutment with the lower segments.

U.S. Pat. No. 4,289,463 describes a segmented mould for moulding tire casings having a fixed lower mould part for moulding one side wall of the tire, a series of moulding segments for moulding the tread movably mounted on the lower mould part to be slidable and swingable along radial planes, an axially movable upper mould part for moulding the other side wall of the tire, and means cooperating with the segments to effect the movement thereof along the radial planes.

The mould also has elastic members interposed between the fixed lower mould part and the segments for continuously urging each of said segments toward an open position in which the segments are radially retracted and swung upward and to the outside of the mould to free a passage for the tire when the upper mould part is lifted off.

These members include a first spring for pulling each segment radially outward and a second spring for tilting each segment vertically upward toward an open position.

U.S. Pat. No. 4,580,959 describes a tire vulcanizing press, comprising a frame provided with a lower supporting plate for allowing a mould for vulcanizing the tires to rest upon, and an upper plate that is mobile with respect to the lower plate. The mould comprises a lower cheek, an upper cheek that is mobile with respect to the lower cheek, and a series of sectors, that are mobile with respect to an annular-containing element, each of which is radially mobile with respect to the upper cheek.

The mould further comprises a connecting means for fixing the lower cheek to the lower plate, and the upper cheek and the annular element to the upper mobile cheek, and which comprises a series of rotating bodies on the lower and upper plates which are actionable from the outer side of the plates with respect to the mould.

### SUMMARY OF THE INVENTION

The above disclosed apparatus for moulding and vulcanisation of the tyres may show some drawbacks. For example the Applicant has noted that due to a suction effect at the end of the vulcanization process, in particular during the opening of the mould, adhesion of some sectors to the tyre tread band may occur.

The above adhesion may cause tearing of the tyre tread and/or may give rise to tyre out of round, and/or uneven deformation of belt structure, and/or moulding defects, such as burr and step formation.

In particular, it has been observed that the above adhesion may be particularly detrimental in correspondence of sector blades provided to form sipes in the tyre tread, in that undercuts may be generated.

Moreover, the above adhesion may also cause damages of the sectors. In fact, the adhered mould sectors separate late from the vulcanized tread band when they are in a higher position with respect to the lower plate. The fall from that higher position, under the action of their weight, may give rise to damages in the lower portion of the mould sectors and in the upper portion of the lower plate.

The Applicant has now found that the above drawbacks can be reduced or even eliminated providing a radially outward thrust action on the mould sectors (and/or on the sector carriers) during opening of the mould. The above action is different from and additional to the action of the actuator designated for the displacement of the sectors from the closed condition to the open condition.

Further, the Applicant has found that said radially outward thrust action on each mould sector should be able to pull out the sector surface ridges and blades from the vulcanized tyre, during the displacement of said mould sectors from the closed condition to the open condition.

In a first aspect, the present invention relates to an apparatus for moulding and vulcanisation of tyres for vehicle wheels, comprising a vulcanisation press and a vulcanisation mould associated with said press, said apparatus comprising:
a pair of plates axially movable and designed to operate on the tyre bead and sidewalls;
a plurality of circumferentially distributed mould sectors radially movable close to each other and designed to operate on the tread band of the tyre;
a plurality of sector carriers, designed to support the mould sectors and movable together with the sectors;
each mould sector comprising a plurality of surface ridges matching the outer surface of the tyre tread band to be obtained;
the plates and sectors being mutually movable between an open condition at which they are spaced apart to enable loading of the tyre to be moulded and vulcanised, and a closed condition at which they define a moulding cavity having a geometric configuration matching the outer surface of the tyre to be obtained; wherein:
   at least one first thrusting device is provided between each sector carrier and one of the plates to exert radially outward thrust action on each mould sector or each sector carrier, during the displacement of said mould sectors from the closed condition to the open condition, at most until the sector surface ridges are entirely pulled out of the vulcanized tyre.

For the purpose of the present invention by “between each sector carrier and one of the plates” it is intended a mould portion comprised between the sector carriers and the plates (such mould portion including the sectors).

Moreover, the terms “radial”, “radially”, “axial”, “axially”, used with reference to the vulcanization and mould apparatus, have to be intended as referring to the radial and axial direction of the tyre to be vulcanised and moulded.

In particular, the apparatus comprises at least one second thrusting device between each sector carrier and the other one of the plates to exert a radially outward thrust action on each mould sector or each sector carrier during the displacement of said mould sectors from the closed condition to the open condition at most until the sector surface ridges are entirely pulled out of the vulcanized tyre.

Preferably, each thrusting device is disposed such that it exerts said thrust action toward the median vertical axis of the mould sector.

In the present description and claims by “median vertical axis of the mould sector” it is intended a vertical axis dividing in two equal parts the mould sector and parallel to the axial direction of the tyre to be vulcanized.

According to a preferred embodiment, each thrusting device is disposed such that it abuts, on closure of the mould, against the mould sector or sector carrier and detaches from the mould sector, during the opening of the mould.

Preferably, each thrusting device is housed in a seat formed in a plate in such a manner as to project from said seat for abutment against the respective mould sector or sector carrier, on closure of the mould.

An exemplary thrusting device suitable for being used in the apparatus for moulding and vulcanising a tyre according to the invention may comprise a piston element and at least one spring adapted to exert a thrust action on said piston element.

In a second aspect, the present invention relates to a process for controlling a detachment of the mould sectors from vulcanised tyres in a vulcanisation mould comprising a plurality of circumferentially distributed mould sectors, comprising a plurality of surface ridges, and a plurality of sector carriers; the process comprising:
loading a green tyre into the vulcanisation mould (2);
vulcanising and moulding the green tyre;
opening the mould (2);
   wherein, during said opening of the mould:
exerting a radially outward thrust action on each mould sector (7) or on each sector carrier (6);
ending said radially outward thrust action when a radial distance not substantially greater than the maximum height of the surface ridges is achieved between the vulcanised tyre and mould sectors (7).

For the purpose of the present invention by “height of the surface ridge” it is intended the size of the ridge corresponding to the depth of the groove to be realised on the tread band.

Moreover, the expression “radial distance . . . between the vulcanised tyre and mould sectors”, have to be intended as referring to the distance in the radial direction between the surface of the vulcanised tyre and the surface of the mould sector measured on portions respectively without grooves and ridges.

Advantageously, the radially outward thrust action is exerted on all mould sectors or sector carriers substantially simultaneously.

Preferably, the radially outward thrust action on each mould sector or sector carrier is exerted by a thrusting device abutting, on closure of the mould, against the mould sector or sector carrier and detaching from the mould sector or sector carrier on opening of the mould.

Further features and advantages will become more apparent from the detailed description of a preferred but not exclusive embodiment of a process and an apparatus for moulding and vulcanisation of tyres for vehicle wheels in accordance with the present invention. This description will be set out hereinafter with reference to the accompanying drawings, given by way of non-limiting example, in which:

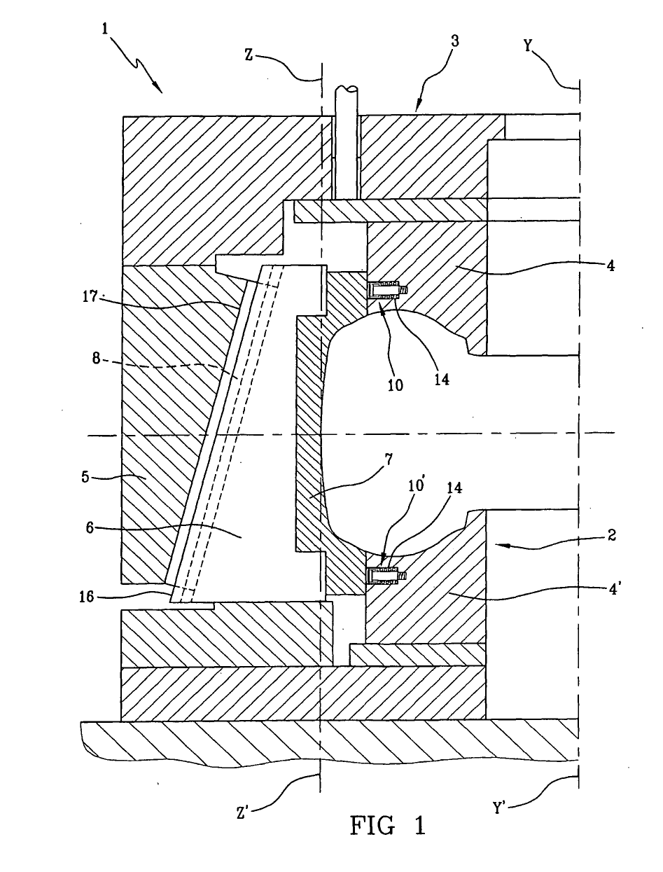

FIG. 1 is a diagrammatic section view of part of the apparatus of the invention with a mould portion in a closed condition to enable processing of the tyre to be vulcanised;

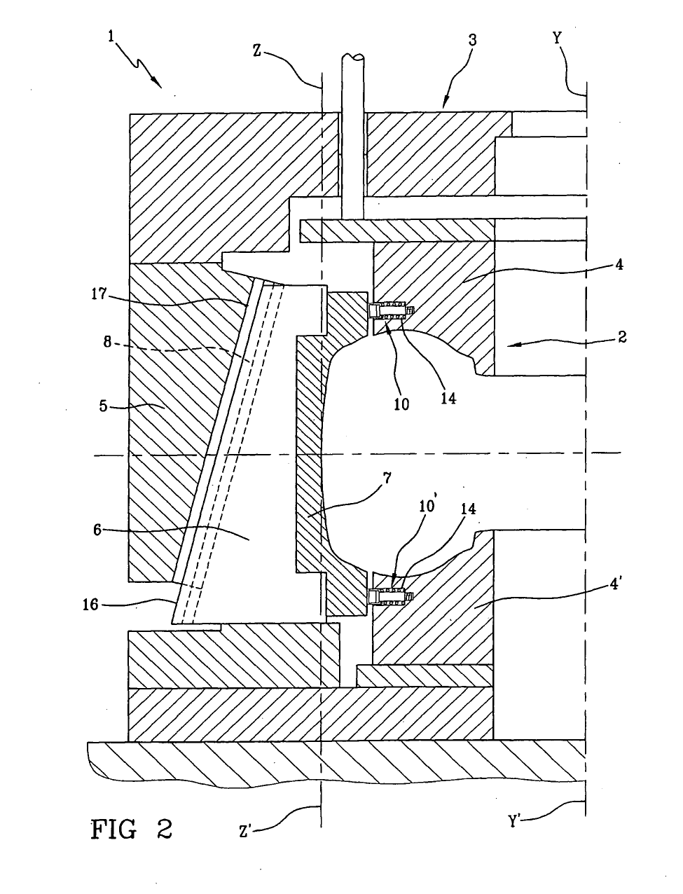

FIG. 2 is a diagrammatic section view of part of the apparatus of the invention with a mould portion after few moments during the displacement of the mould sectors from the closed condition to the open condition;

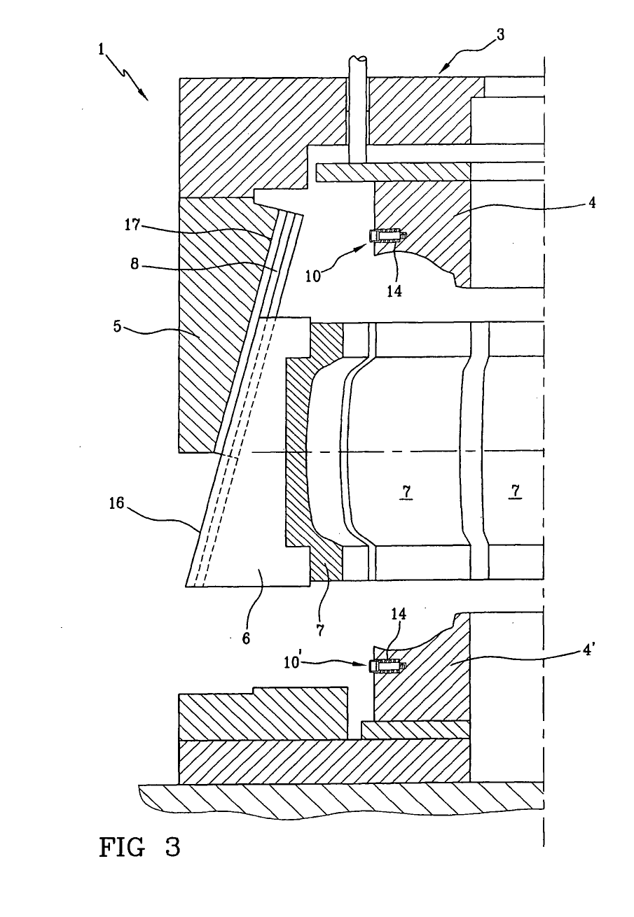

FIG. 3 is a diagrammatic section view of part of the apparatus of the invention with a mould portion in an open condition to enable unloading of the vulcanised tyre;

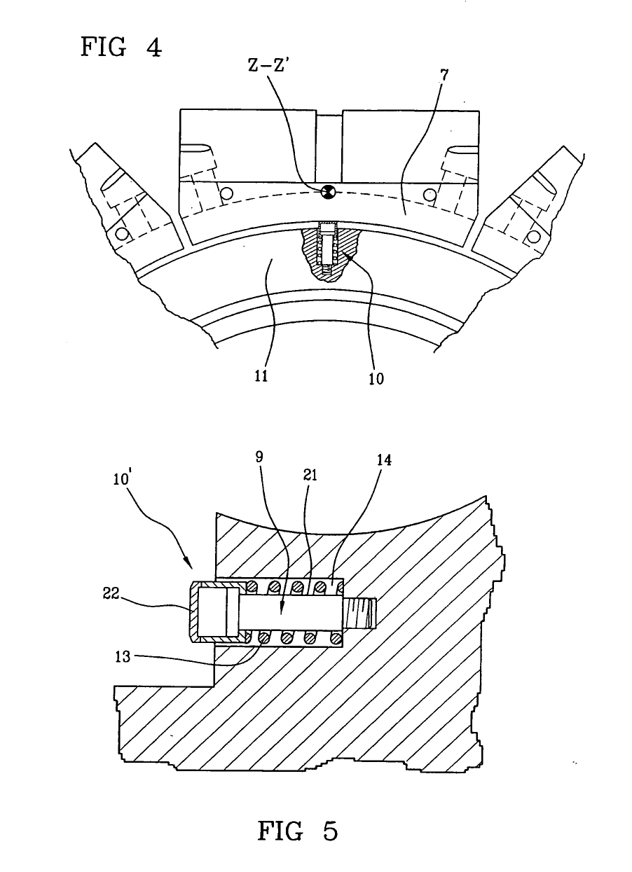

FIG. 4 shows a cross-section view of a mould portion according to the present invention;

FIG. 5 is an enlarged view of an embodiment of an exemplary thrusting device in accordance with the invention.

With reference to the drawings, an apparatus for moulding and vulcanisation of tyres for vehicle wheels in accordance with the present invention has been generally denoted with 1.

Apparatus 1 comprises a vulcanisation mould 2 associated with a vulcanisation press 3 only diagrammatically shown as it can be made in any manner convenient for a person skilled in the art. Mould 2 can be made up of two side portions 4,4′ of annular conformation known as “plates” that are coaxially opposite along the central axis Y-Y′ of the mould 2, axially movable relative to each other and substantially corresponding to the bead and the sidewalls of the tyre to be moulded and vulcanised.

Disposed between said plates 4,4′ is a central annular portion comprising a plurality of mould sectors 7 circumferentially disposed around the mould axis Y-Y′. Usually the mould sectors are at least four. Preferably said sectors are not more than ten.

A plurality of sector carriers 6, is provided to support one or more mould sectors 7.

An actuator 5 is connected to the sector carriers 6 and the vulcanisation press 3 to operate the displacement of the mould sectors 7 from the closed condition to the open condition and vice versa.

Preferably each mould sector 7 is an enbloc mould sector.

In the present specification and in the claims by “enbloc mould sector” it is intended a mould sector realised in one piece, i.e. a mould sector adapted to impress a tread pattern portion on the whole width of the tread of a tire to be vulcanised.

The actuator 5 comprises a cone-shaped ring at a radially outer position with respect to the sector carriers 6 to support said sector carriers 6 in an axially slidable manner.

The cone-shaped ring of the actuator 5 has an inner peripheral surface which projects toward the sector carriers 6 and contacts them.

Such inner surface of the cone shaped ring of the actuator 5 forms a tapered cam surface 17 having an diameter which progressively increases downwards.

On the other hand, sector carriers 6 are provided with outer peripheral surfaces 16 tapered upwards and corresponding to the tapered cam surface 17 of the cone-shaped ring of the actuator 5.

In this way, the mould sectors 7 at which the sector carriers 6 are connected can be displaced radially inwards and outward based on the downward/upward of the cone shaped ring 5.

In particular, a guide element 8 may be placed between the corresponding tapered surfaces 16 and 17, said guide element 8 may be enclosed to the inclined surface 17 of the cone-shaped ring 5 to enable sliding of the sector carrier 6 thereon.

The mould sectors 7 are radially movable in both ways substantially at right angles to the central vertical axis Y-Y′ of the mould between a closed condition (shown in FIG. 1), and an open condition (shown in FIG. 3).

In the closed condition the mould sectors 7 and the opposite plates 4,4′ close to each other define a moulding cavity conforming in shape to the outer surface of the tyre to be obtained.

On the contrary, in the open position the mould sector 7 and the plates 4,4′ are spaced apart, so as to allow removal of the vulcanised tyre.

The mould sectors 7 are designed to operate, when the mould is in a closed position, on the tread band of the tyre to define a so-called tread pattern in said tread band.

To this end, they are provided, on their inner surfaces designed to come into contact with the tread band, with a plurality of surface ridges so as to generate longitudinal and/or transverse grooves delimiting the ribs and/or blocks of the desired tread pattern. A plurality of blades may also be provided to generate sipes in the tread band.

For the purposes of the present invention, the term “ridge” encompass both ridges adapted to generate longitudinal and/or transversal grooves and blades adapted to generate sipes in the tread band.

Plates 4,4′ on the contrary and as previously mentioned, operate on the tyre sidewalls and, if raised portions are wished to be made thereon to define graphic identification elements of the tyre (such as the tyre trademark or size) for example, they are usually provided with corresponding cavities adapted to generate said raised portions.

At least one first thrusting device 10 is provided between each mould sector 7 and one plate 4 or 4′. The above device exerts a radially outward thrust action on each mould sector 7, during the displacement of the mould sector 7 from the closed condition to the open condition. The radially outward thrust action is performed at, most until the sector surface ridges are entirely pulled out of the vulcanized tyre.

According to a preferred embodiment shown in the drawings, the apparatus comprises also at least one second thrusting device 10′.

Each second thrusting device 10′ is placed between each mould sector 7 and the other of the plates 4,4′ to exert a radially outward thrust action on every mould sector 7, during the displacement of said mould sectors 7 from the closed condition to the open condition. The radially outward thrust action is performed at most until the sector surface ridges are entirely pulled out of the vulcanized tyre.

All the thrusting devices 10,10′ exert substantially simultaneously the radially outward thrust action on all the mould sectors 7.

Moreover, the thrusting devices 10 connected to the upper plate 4 are positioned in the correspondent position with respect to the thrusting devices 10′ connected to the lower plate 4′ in such a way that for each mould sector 7 the upper thrusting device 10 and the lower thrusting device 10′ exert substantially simultaneously the thrust action in the direction of the median vertical axis z-z′ of the same mould sector 7.

In other words, two thrusting devices 10,10′ act on each mould sector 7 and they are disposed to act on a upper and lower side of each mould sector 7 so that the thrusting devices 10,10′ carry out balancing of the forces acting on the median vertical axis Z-Z′ of the respective mould sector 7; see FIGS. 1,4.

Each thrusting device 10,10′ is disposed so as to abut against a mould sector 7, on closing of the mould 2 and during the initial moments of the opening of the mould. In detail, each thrusting device 10,10′ is housed in a suitable seat 14 formed in the plates 4,4′ in such a manner as to project from said seat 14 for abutment against the mould sector 7, during the initial moments of the opening of the mould.

In particular, each thrusting device 10,10′ is disposed such that it abuts, on closure of the mould 2, against the respective mould sector 7 and is detached from the mould sector 7 when the opening of the mould is completed.

According to an exemplary embodiment of the present invention, each thrusting device 10,10′ has a piston element 9 and at least one spring 13 designed to exert a thrust action on the piston element 9. In detail, the piston element 9 is provided with an abutment head 22 and a rod 21 at least partly slidable within the seat 14, see FIG. 5.

The spring 13 is a compression helical-type spring coaxially mounted around the rod 21 to exert a thrust action on the abutment head 22.

Alternatively, the thrusting devices 10,10′ could be represented by any device (known to a person skilled in the art) capable of exerting a radially outward thrust action on the mould sectors, such as an hydraulic piston.

Conveniently, the thrusting device should exert on the mould sector a force of at least 4000 N (Newton). Preferably the thrusting device should exert on the mould sector a force not more than 15000 N.

According to another embodiment, not shown in the drawings, the thrusting devices 10,10′ could be arranged between each sector carrier 6 and one of the plates 4;4′.

In that case, the thrusting devices 10,10′ exert the radially outward thrust action directly on each sector carrier 6, during the displacement of the mould sectors 7 from the closed condition to the open condition. The thrust action is performed at most until the sector surface ridges are entirely pulled out of the vulcanized tyre.

Taking into account the particular mechanical features of the apparatus according to the present invention, it appears that the above described apparatus can be advantageously used for carrying out the moulding and vulcanisation of tyres for vehicle wheels, thus reducing the drawbacks of the known moulding and vulcanisation apparatus.

In particular the above described apparatus avoids or in any case reduces tyre out of round, and/or uneven deformation of belt structure and/or moulding defects on the finished tyre, such as burr and step formation.

In operation, in known manner, the tyre to be vulcanized or green tyre, is loaded in the opened mould i.e. with the plates 4,4′ and the mould sectors 7 spaced apart.

At this point, the vulcanisation press 3 operate the axial approach of the plates 4,4′ and, by the actuator 5, the radial displacement of the mould sectors 7 in such a way that the mould 2 is brought in the closed condition, enclosing the tyre in the moulding cavity.

Then, the inflation of a vulcanisation bladder of elastomeric material, placed inside the tyre, with steam and/or other fluid at high temperature and pressure, pushes the tyre against the surfaces of the sectors and plates defining the moulding cavity.

Following cross-linking, the pneumatic tyre stabilise into the geometric conformation imposed on it by the moulding cavity.

Then, the press operate the opening of the mould for the extraction of the vulcanised finished tyre.

During the opening of the mould 2, the mould sectors 7 are displaced from the closed condition to the open condition and in particular during the initial moments of this displacement all the thrusting devices 10,10′ exert substantially simultaneously a radially outward thrust on the mould sectors 7 and/or on the sector carriers 6.

It is pointed out that this radially outward thrust action is an additional action with respect to that exerted by the actuator 5 to displace the mould sector 7 to the open condition. It is also pointed out that this radially outward thrust action acts for detaching the mould sectors 7 from the vulcanised tyre during the first moments of the opening of the mould.

In particular, the thrust action performed by the devices 10,10′ is exerted only until the surface ridges are not entirely pulled out from the vulcanized tyre.

In other words, the action of the thrusting device 10,10′ terminates as soon as the radial displacement of the mould sectors is at most substantially equal to the maximum height of the ridges.

Moreover, during the opening of the mould 2, initially the thrusting devices 10,10′ abut against the mould sectors 7 and/or the sector carriers 6, but after few moments, after the extraction of the sector surface ridges from the vulcanized tyre, the elastic device 10,10′ end their function, and completely detach from the mould sectors 7 and/or the sector carriers 6.

In that condition the mould sectors 7 operated by the actuator 5 continue their displacement to the open condition shown in FIG. 3.

1-25. (canceled)

26. An apparatus for moulding and vulcanisation of tyres for vehicle wheels, comprising a vulcanisation press and a vulcanisation mould associated with said press, comprising:
a pair of plates axially movable and designed to operate on a tyre bead and sidewalls;
a plurality of circumferentially distributed mould sectors radially movable close to each other and designed to operate on a tread band of the tyre;
a plurality of sector carriers, designed to support the mould sectors and movable together with the sectors;
each mould sector comprising a plurality of surface ridges matching an outer surface of the tyre tread band to be obtained,
the plates and sectors being mutually movable between an open condition at which they are spaced apart to enable loading of a tyre to be moulded and vulcanised, and a closed condition at which they define a moulding cavity having a geometric configuration matching an outer surface of the tyre to be obtained;
wherein at least one first thrusting device is provided between each sector carrier and one of the plates to exert a radially outward thrust action on each mould sector or each sector carrier during the displacement of said mould sectors from the closed condition to the open condition at most until sector surface ridges are entirely pulled out of a vulcanized tyre.

27. The apparatus for moulding and vulcanisation of tyres for vehicle wheels as claimed in claim 26, wherein each mould sector is an enbloc mould sector.

28. The apparatus for moulding and vulcanisation of tyres for vehicle wheels as claimed in claim 26, comprising at least one actuator connected to said sector carriers and said vulcanization press to operate displacement of said mould sectors from the closed condition to the open condition and vice versa.

29. The apparatus for moulding and vulcanisation of tyres for vehicle wheels as claimed in claim 26, wherein the thrusting devices exert a radially outward thrust action on the mould sectors and the sector carriers.

30. The apparatus for moulding and vulcanisation of tyres for vehicle wheels as claimed in claim 26, comprising at least a second thrusting device between each sector carrier and another one of the plates to exert a radially outward thrust action on each mould sector or each sector carrier during displacement of said mould sectors from the closed condition to the open condition at most until the sector surface ridges are entirely pulled out from the vulcanized tyre.

31. The apparatus for moulding and vulcanisation of tyres for vehicle wheels as claimed in claim 30, wherein each thrusting device is disposed such that said thrusting device exerts thrust action toward a median vertical axis of the mould sector.

32. The apparatus for moulding and vulcanisation of tyres for vehicle wheels in claim 26, wherein all thrusting devices exert said thrust action substantially simultaneously.

33. The apparatus for moulding and vulcanisation of tyres for vehicle wheels as claimed in claim 26, wherein each thrusting device is disposed such that said thrusting device abuts, on closure of the mould, against the mould sector or sector carrier and detaches from the mould sector or sector carrier during opening of the mould.

34. The apparatus for moulding and vulcanisation of tyres for vehicle wheels as claimed in claim 26, wherein said apparatus comprises a plurality of guide elements on which said plurality of sector carriers slides for movement of the mould sectors from the closed condition to the open condition and vice versa.

35. The apparatus for moulding and vulcanisation of tyres for vehicle wheels as claimed in claim 28, wherein the actuator comprises a cam member, capable of being operatively connected to the vulcanization press, comprising a tapered cam surface slidable on a correspondent external tapered surface of the sector carrier for moving the mould sectors from the closed condition to the open condition and vice versa.

36. The apparatus for moulding and vulcanisation of tyres for vehicle wheels as claimed in claim 30, wherein each thrusting device comprises: a piston element and at least one spring capable of being adapted to exert a thrust action on said piston element.

37. The apparatus for moulding and vulcanisation of tyres for vehicle wheels as claimed in claim 30, wherein each thrusting device comprises a hydraulic piston element.

38. The apparatus for moulding and vulcanization of tyres for vehicle wheels as claimed in claim 36, wherein said at least one spring comprises a compression helical spring.

39. The apparatus for moulding and vulcanisation of tyres for vehicle wheels as claimed in claim 26, wherein each thrusting device is housed in a seat formed in a plate in such a manner as to project from said seat for abutment against the respective mould sector or sector carrier, on closure of the mould.

40. The apparatus for moulding and vulcanisation of tyres for vehicle wheels as claimed in claim 26, wherein the thrusting devices exert a radially outward thrust action on the mould sectors and on the sector carriers.

41. A process for controlling a detachment of mould sectors from a vulcanised tyre in a vulcanization mould comprising a plurality of circumferentially distributed mould sectors comprising a plurality of surface ridges and a plurality of sector carriers, comprising:
loading a green tyre into the vulcanization mould;
vulcanising and moulding a green tyre; and
opening the mould,
wherein, during said opening of the mould:
exerting a radially outward thrust action on each mould sector or on each sector carrier; and
ending said radially outward thrust action when a radial distance not substantially greater than a maximum height of surface ridges is achieved between the vulcanised tyre and mould sectors.

42. The process for controlling a detachment of mould sectors from a vulcanised tyre as claimed in claim 41, wherein the radially outward thrust action is exerted on enbloc mould sectors.

43. The process for controlling a detachment of mould sectors from a vulcanised tyre as claimed in claim 41, wherein the vulcanisation mould comprises a pair of plates axially movable and designated to operate on a tyre bead and sidewalls.

44. The process for controlling a detachment of mould sectors from a vulcanised tyre as claimed in claim 41, wherein the mould sectors are radially movable close to each other and designed to operate on a tread band of the tyre.

45. The process for controlling a detachment of mould sectors from a vulcanised tyre as claimed in claim 41, wherein the sector carriers are designed to support the mould sectors and are movable together with the mould sectors.

46. The process for controlling a detachment of mould sectors from a vulcanised tyre as claimed in claim 43, wherein the plates and the sectors are mutually movable between an open condition at which they are spaced apart to enable loading of the tyre to be moulded and vulcanised, and a closed condition at which they define a moulding cavity having a geometric configuration matching an outer surface of the tyre to be obtained.

47. The process for controlling a detachment of mould sectors from a vulcanised tyre as claimed in claim 41, wherein a pulling action to operate movement of said mould sectors from the closed condition to the open condition and vice versa is exerted by at least one actuator.

48. The process for controlling a detachment of mould sectors from a vulcanised tyre as claimed in claim 43, wherein the vulcanising step comprises:
pushing the tyre against surfaces of the sectors and plates defining a moulding cavity and stabilising thereof, following cross-linking, into a geometric conformation imposed thereon, inflating a vulcanisation bladder of elastomeric material placed inside the tyre, with steam and/or other fluid at high temperature and pressure.

49. The process for controlling a detachment of mould sectors from a vulcanised tyre as claimed in claim 41, wherein the radially outward thrust action is exerted on all mould sectors or sector carriers substantially simultaneously.

50. The process for controlling a detachment of mould sectors from a vulcanised tyre as claimed in claim 41, wherein the radially outward thrust action on each mould sector is exerted toward a median vertical axis of the mould sector.
